(19) United States
(12) Patent Application Publication
(10) Pub. No.: US 2024/0331705 A1
(43) Pub. Date: Oct. 3, 2024

(54) METHODS AND APPARATUS TO MODEL SPEAKER AUDIO

(71) Applicant: INTEL CORPORATION, Santa Clara, CA (US)

(72) Inventors: Michal Karzynski, Gdynia (PL); Adam Kupryjanow, Gdansk (PL); Srikanth Potluri, Folsom, CA (US)

(21) Appl. No.: 18/194,248

(22) Filed: Mar. 31, 2023

(51) Int. Cl. G10L 17/04

(52) U.S. Cl. CPC G10L 17/04

(57) ABSTRACT

Methods, apparatus, systems, and articles of manufacture are disclosed. An example apparatus includes: interface circuitry; instructions; and programmable circuitry to at least one of execute or instantiate the instructions to: calculate a sample embedding vector that characterizes a speaker based on a first audio signal; perform a first update of a personal embedding vector based on the sample embedding vector, the updated personal embedding vector to characterize the speaker based on a second audio signal and the first audio signal, and perform a second update of the personal embedding vector based on the first update and a universal embedding vector.

### FIELD OF THE DISCLOSURE

This disclosure relates generally to voice detection and, more particularly, to methods and apparatus to isolate speaker audio.

### BACKGROUND

In recent years, growing desires to work, learn, and communicate with others remotely have led to an increased use of voice calls. As used herein, a voice call refers to any exchange of audio data between two or more remotely located devices. Voice calls can be implemented across a wide variety of use cases, devices, and communication protocols such as land-line phones using Integrated Services Digital Network (ISDN), cellular devices using 3G, 4G, 5G, etc., and internet-enabled devices using Voice over Internet Protocol (VoIP).

### BRIEF DESCRIPTION OF THE DRAWINGS

FIG. 1 is a first example of embedding generator circuitry.

FIG. 2 is a second example of embedding generator circuitry.

FIG. 3 is a flowchart representative of example machine readable instructions and/or example operations that may be executed by example processor circuitry to implement the embedding generator circuitry of FIGS. 1 and 2.

FIG. 4 is a block diagram of an example processing platform including processor circuitry structured to execute the example machine readable instructions and/or the example operations of FIG. 3 to implement the embedding generator circuitry of FIGS. 1 and 2.

FIG. 5 is a block diagram of an example implementation of the processor circuitry of FIG. 4.

FIG. 6 is a block diagram of another example implementation of the processor circuitry of FIG. 4.

FIG. 7 is a block diagram of an example software distribution platform (e.g., one or more servers) to distribute software (e.g., software corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), “X” Processor Units (XPUs), or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Generally, multiple sources of audio recorded from a microphone used in a voice call can be organized into one of three categories. The first category, main speaker audio, refers to voice data corresponding to the individual that is actively using the microphone to participate in the voice call. The second category, parasitic speaker audio, refers to any voice data that is detected by the microphone but does not correspond to the main speaker. Parasitic speaker audio may be generated by other individuals in the same environment as the main speaker during the voice call. The third category, parasitic noise audio, refers to any audio data that does not correspond to a human voice (e.g., vehicles driving, dogs barking, etc.)

To improve the clarity and user experience of the voice calls, an example electronic device may seek to transmit only main speaker audio to the receiver device(s). To do so, the example electronic device must isolate the main speaker audio from both the parasitic noise audio and the parasitic speaker audio from signals generated by the microphone.

Example methods, apparatus, and systems described herein automatically generate a model of a main speaker's voice without the need for an enrollment process. Example embedding generator circuitry isolates a speaker audio and uses the model to encode a personal embedding vector. In some examples, the embedding generator circuitry iteratively updates the personal embedding vector with: (1) additional speaker audio that satisfies a distance threshold, and (2) a universal embedding vector that characterizes human voice (e.g., all human voice). In some examples, the embedding generator circuitry is also tunable so that updates to an output vector can be based on a different proportions of new speaker audio and the universal embedding vector.

In some examples, the embedding generator circuitry generates an output vector that characterizes a main speaker based only on audio used in a voice call. That is, in such examples, the embedding generator circuitry does not require a separate enrollment process. Accordingly, such example embedding generator circuitry supports high quality user experiences and mitigates the use of computational resources.

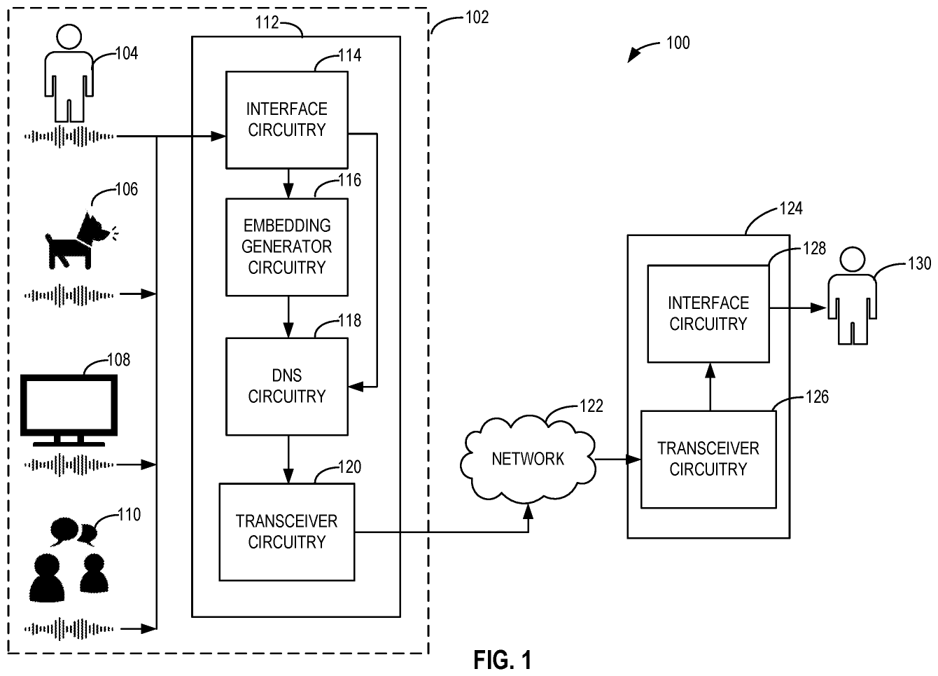

FIG. 1 illustrates a first example implementation of embedding generator circuitry. The example system 100 includes an example communication device 112, an example network 122, and an example communication device 124. The example communication device 112 may operate in an example environment 102 that also includes an example main speaker 104 and example audio sources 106, 108, 110. The example communication device 112 includes example interface circuitry 114, example embedding generator circuitry 116, example DNS circuitry 118, and example transceiver circuitry 120. The example communication device 124 includes example transceiver circuitry 126 and example interface circuitry 128. The example communication device 124 corresponds to an example participant 130 and may operate outside of the environment 102.

The example of FIG. 1 shows an example voice call between the main speaker 104 and the participant 130. In particular, the example of FIG. 1 illustrates a portion of the example voice call in which audio data is generated by the main speaker 104 and is transmitted to the participant 130. In some examples, the example communication device 112 includes additional components and/or connections not illustrated in FIG. 1. In such examples, the additional components support an alternate portion of the example voice call in which audio data is: (1) generated by the participant 130 and (2) transmitted to the main speaker 104.

The example main speaker 104, and the example audio sources 106, 108, 110 are sources of audio within the environment 102. In particular, the main speaker 104 generates main speaker audio. The example audio source 106, a dog barking, generates parasitic noise audio. Similarly, the example audio source 108, a television, also generates parasitic noise audio. Finally, example audio source, 108, a conversation between two other individuals, generates parasitic speaker audio.

The example communication device 112 implements the voice call by exchanging data with the example communication device 124. In particular, the example communication device 112 only transmits the main speaker audio in accordance with the teachings of this disclosure. The example communication device 112 of FIG. 1 may be instantiated (e.g., creating an instance of, bring into being for any length of time, materialize, implement, etc.) by processor circuitry such as a central processing unit executing instructions. Additionally or alternatively, the example communication device 112 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

Within the example communication device 112, the example interface circuitry 114 connects to a microphone that records the main speaker 104, and the example audio sources 106, 108, 110. The microphone may be implemented either internally or externally from the example communication device 112. The example interface circuitry 114 provides an audio signal generated by the microphone to the embedding generator circuitry 116.

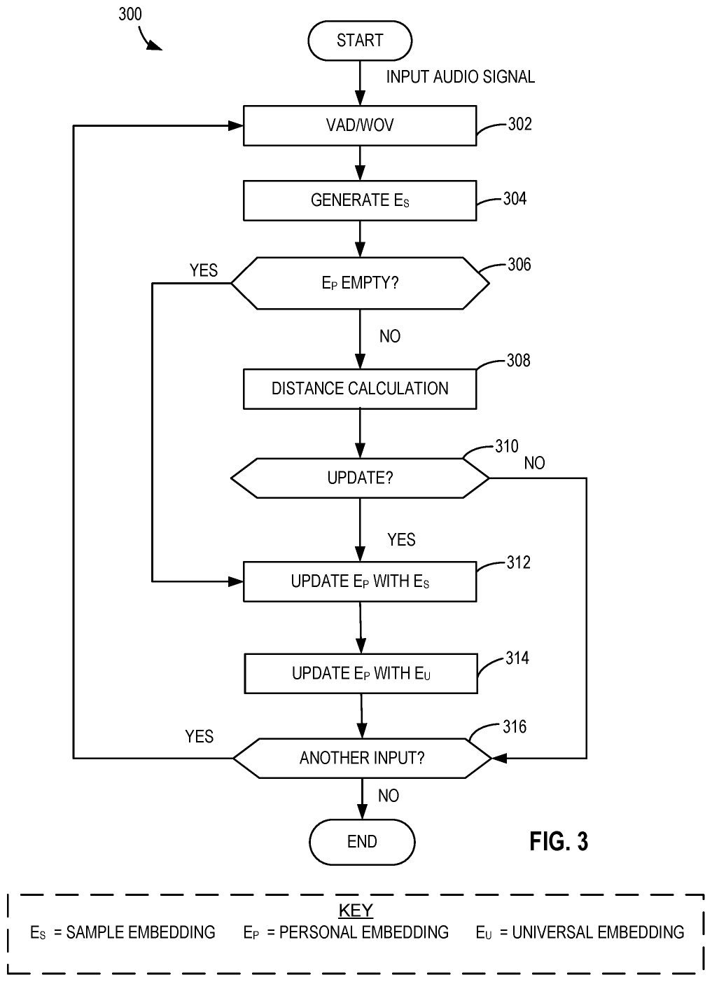

In some examples, the interface circuitry 114 also connects to an internal or external audio generator so that the main speaker 104 can hear when the participant 130 is speaking on the voice call. The audio generator may be implemented as earbuds, headphones, a speaker, etc. In some examples, the interface circuitry 114 is instantiated by processor circuitry executing interface instructions and/or configured to perform operations such as those represented by the flowchart of FIG. 3.

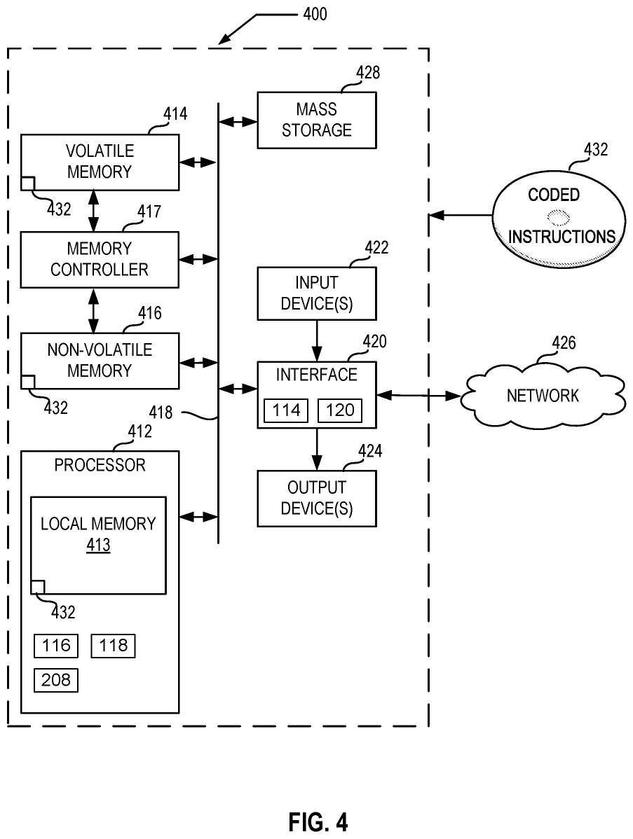

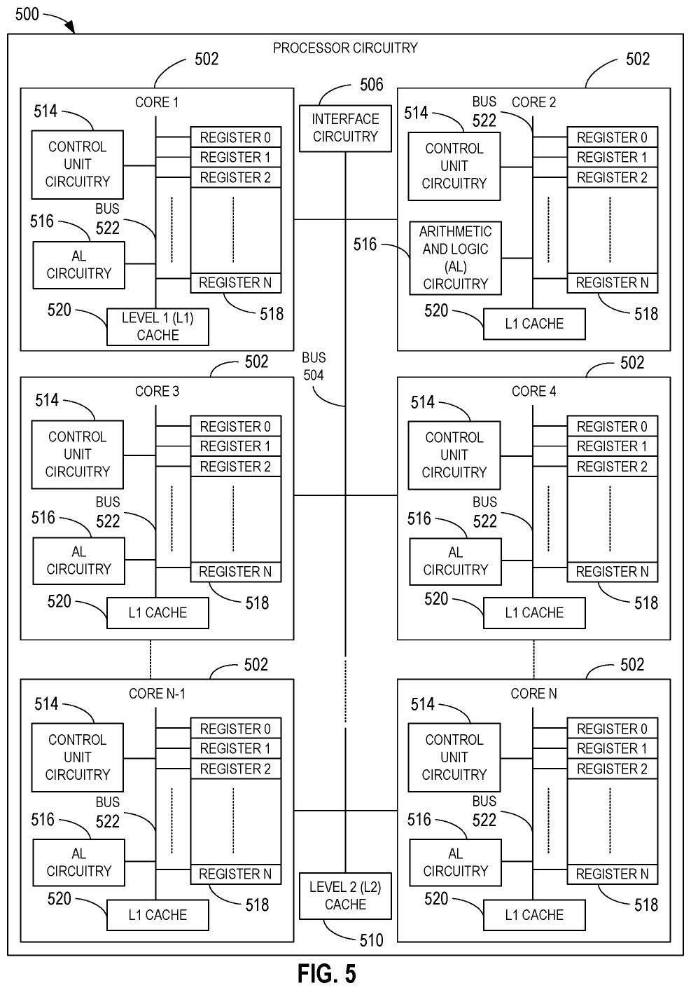

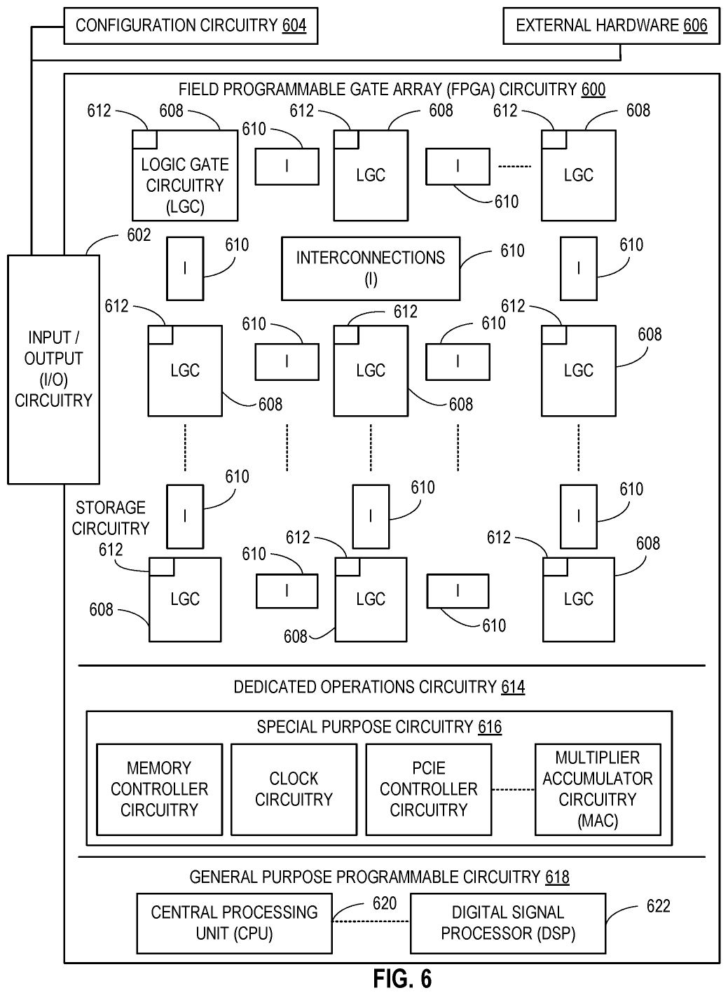

In some examples, the communication device 112 includes means for obtaining an audio signal. For example, the means for obtaining may be implemented by interface circuitry 114. In some examples, the interface circuitry 114 may be instantiated by processor circuitry such as the example programmable circuitry 412 of FIG. 4. For instance, the interface circuitry 114 may be instantiated by the example microprocessor 500 of FIG. 5 executing machine executable instructions such as those implemented by at least block 302 of FIG. 3. In some examples, the interface circuitry 114 may be instantiated by hardware logic circuitry, which may be implemented by an ASIC, XPU, or the FPGA circuitry 600 of FIG. 6 structured to perform operations corresponding to the machine readable instructions. Additionally or alternatively, the interface circuitry 114 may be instantiated by any other combination of hardware, software, and/or firmware. For example, the interface circuitry 114 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

Within the example communication device 112, the example embedding generator circuitry 116 generates an embedding vector that characterizes the voice of the main speaker 104 in accordance with the teachings of this disclosure. As used above and herein, an embedding vector refers to a list of values that represent audio data. For example, an embedding vector with fifty values corresponds to fifty properties of an audio signal. The fifty properties can be tuned (i.e., the fifty values can be changed) until they uniquely identify a human voice present in the audio signal. In some examples, an embedding vector is referred to as a voice model. In FIG. 1, the example embedding generator circuitry 116 provides a personal embedding vector to the example DNS circuitry 118. In some examples, the embedding generator circuitry 116 is instantiated by processor circuitry executing embedding generator instructions and/or configured to perform operations such as those represented by the flowchart of FIG. 3.

In some examples, the communication device 112 includes means for generating an embedding vector. For example, the means for determining may be implemented by embedding generator circuitry 116. In some examples, the embedding generator circuitry 116 may be instantiated by processor circuitry such as the example programmable circuitry 412 of FIG. 4. For instance, the embedding generator circuitry 116 may be instantiated by the example microprocessor 500 of FIG. 5 executing machine executable instructions such as those implemented by at least blocks 302-316 of FIG. 3. In some examples, the embedding generator circuitry 116 may be instantiated by hardware logic circuitry, which may be implemented by an ASIC, XPU, or the FPGA circuitry 600 of FIG. 6 structured to perform operations corresponding to the machine readable instructions. Additionally or alternatively, the embedding generator circuitry 116 may be instantiated by any other combination of hardware, software, and/or firmware. For example, the embedding generator circuitry 116 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

Within the example communication device 112, the example DNS circuitry 118 uses the personal embedding vector to isolate the main speaker audio within the audio signal provided by the interface circuitry 114. To isolate the main speaker audio, the example DNS circuitry 118 may identify frequencies that correspond to the personal embedding vector and suppress (e.g., apply a filter to) any remaining frequencies. The example DNS circuitry 118 provides the main speaker audio to the transceiver circuitry 120. In some examples, the DNS circuitry 118 is instantiated by processor circuitry executing DNS instructions and/or configured to perform operations such as those represented by the flowchart of FIG. 3.

In some examples, the communication device 112 includes means for isolating voice audio. For example, the means for isolating may be implemented by DNS circuitry 118. In some examples, the DNS circuitry 118 may be instantiated by processor circuitry such as the example programmable circuitry 412 of FIG. 4. For instance, the DNS circuitry 118 may be instantiated by the example microprocessor 500 of FIG. 5 executing machine executable instructions. In some examples, the DNS circuitry 118 may be instantiated by hardware logic circuitry, which may be implemented by an ASIC, XPU, or the FPGA circuitry 600 of FIG. 6 structured to perform operations corresponding to the machine readable instructions. Additionally or alternatively, the DNS circuitry 118 may be instantiated by any other combination of hardware, software, and/or firmware. For example, the DNS circuitry 118 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

Within the example communication device 112, the example transceiver circuitry 120 transmits the main speaker audio to the transceiver circuitry 126 via the network 122. More generally, both the example transceiver circuitry 120, 126 enable the example communication devices 112, 124, respectively, to send and receive audio data over the network 122. In some examples, the transceiver circuitry 120 is instantiated by processor circuitry executing transceiver instructions and/or configured to perform operations such as those represented by the flowchart of FIG. 3.

The example transceiver circuitry 120, 126 may implement any communication protocol supported by the network 122. In the illustrative example of FIG. 1, the network 122 is the Internet and the communication protocol is VoIP. In other examples, the network 122 is a cellular network and the communication protocol is one of 3G, 4G, 5G, etc.

In some examples, the communication device 112 includes means for transmitting data. For example, the means for transmitting may be implemented by transceiver circuitry 120. In some examples, the transceiver circuitry 120 may be instantiated by processor circuitry such as the example programmable circuitry 412 of FIG. 4. For instance, the transceiver circuitry 120 may be instantiated by the example microprocessor 500 of FIG. 5 executing machine executable instructions. In some examples, the transceiver circuitry 120 may be instantiated by hardware logic circuitry, which may be implemented by an ASIC, XPU, or the FPGA circuitry 600 of FIG. 6 structured to perform operations corresponding to the machine readable instructions. Additionally or alternatively, the transceiver circuitry 120 may be instantiated by any other combination of hardware, software, and/or firmware. For example, the transceiver circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The network 122 of FIG. 1 connects and facilitates communication between the example transceiver circuitry 120, 126. In the example of FIG. 1, the network 122 is the Internet. However, the example network 122 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

Outside of the environment 102, the example communication device 124 includes transceiver circuitry 126 to receive the main speaker audio via the network 122. The example transceiver circuitry 126 provides the main speaker to interface circuitry 128 (e.g., speakers, headphones, earbuds, etc.) where it can be heard by the example participant 130. While not illustrated in FIG. 1, the example communication device 124 may also include an instance of the example embedding generator circuitry 116 and the example DNS circuitry 118. In such an example, the embedding generator circuitry 116 generates an embedding vector when the participant 130 is speaking in accordance with the teachings of this disclosure. The example DNS circuitry 118 uses the participant 130 vector to isolate the participant 130 audio from any parasitic noise in the audio signal.

The example embedding generator circuitry 116 and the example DNS circuitry 118 improve the user experience of the example voice call by isolating audio from the main speaker 104 and removing audio from the audio sources 106, 108, 110. Advantageously, the example embedding generator circuitry 116 generates the personal embedding vector using audio from one or more voice calls the main speaker 104 engages in. As a result, the example communication device 112 does not have to support, and the main speaker 104 does not have to engage in, an enrollment process as described above. Accordingly, the example embedding generator circuitry 116 reduces computational resource requirements and improves user experience.

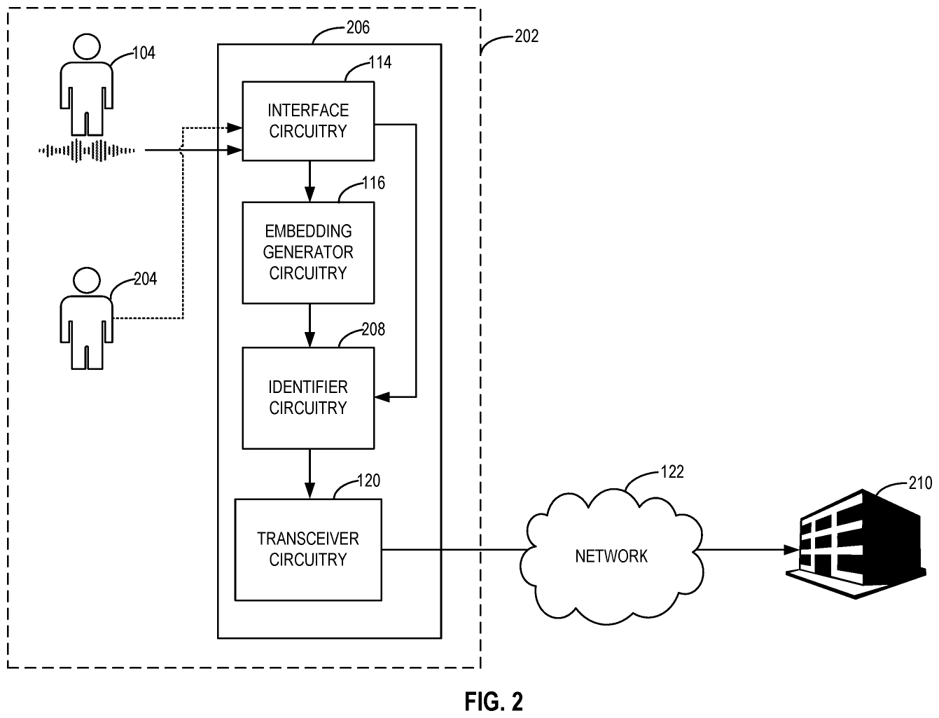

FIG. 2 is a second illustrative example of embedding generator circuitry. FIG. 2 includes an example environment 202, which includes the example main speaker 104, an example second user 204, and an example communication device 206. The example communication device 206 includes the example interface circuitry 114, the example embedding generator circuitry 116, example identifier circuitry 208, and the example transceiver circuitry 120. FIG. 2 also includes the example network 122 and an example central facility 210.

Like the illustrative example of FIG. 1, the main speaker 104 is an individual actively using an electronic device by speaking in FIG. 2. However, in the example environment 202, both the main speaker 104 and the second user 204 use the communication device 206 at different times.

The communication device 206 uses the audio from the main speaker 104 to perform operations. The operations may correspond to applications that include but are not limited to a voice call, voice to text conversion, etc. The example communication device 206 of FIG. 2 may be instantiated (e.g., creating an instance of, bring into being for any length of time, materialize, implement, etc.) by processor circuitry such as a central processing unit executing instructions. Additionally or alternatively, the example communication device 206 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

Within the example communication device 206, the example interface circuitry 114, the example embedding generator circuitry 116, and the example transceiver circuitry 120 are implemented as described above in connection with FIG. 1. That is, the example interface circuitry 114 connects to a microphone that detects more than one source of audio, the example embedding generator circuitry 116 generates a user embedding vector of the main speaker 104 in accordance with the teachings of this disclosure, and the example transceiver circuitry 120 sends and receives data over the network 122. In some examples, the embedding generator circuitry 116 additionally generates a second user embedding vector based on the second user 204 when the second user 204 is speaking.

Within the example communication device 206, the identifier circuitry 208 obtains an audio signal from the interface circuitry 114. The example identifier circuitry 208 then compares the audio signal to one or both of: (1), the first user embedding vector of the main speaker 104, and (2) the second user embedding vector of the second user 204. The example identifier circuitry 208 uses the comparison(s) to identify which individual within the environment 202 is currently speaking into the microphone.

The example identifier circuitry 208 provides the voice identification to the transceiver circuitry 120. In turn, the example transceiver circuitry 120 transmits the voice identification to the central facility 210 via the network 122. In some examples, the example transceiver circuitry 120 sends and/or receives additional data not visualized in FIG. 2.

Outside the environment 202, the example central facility 210 refers to an entity that seeks to distinguish the voice of the main speaker 104 and the voice of the second user 204. The example central facility 210 uses the voice identification to facilitate the operations and/or enhance the user experience of the communication device 206.

In a first example, the central facility 210 may manage or develop a software application that runs on the communication device 206. Using the voice identification, the software application may utilize a first configuration (e.g., visual UI themes, settings, etc.) when the main speaker 104 is speaking into a microphone connected to the communication device 206. In the first example, the software application then switches to a second configuration chosen by the second user 204 when the voice identification indicates the second user 204 is speaking into a microphone connected to the communication device 206.

In a second example, the central facility 210 uses the voice identification to log when a given individual is speaking and correlate the individual to other metadata corresponding to the electronic device (e.g., which applications are currently running on the communication device 206, which configurations are enabled, etc.). In such a second example, the central facility 210 then uses the correlations to determine consumer usage statistics that can be used for product development, targeted advertising, etc.

The illustrative example of FIG. 2 shows that the user embedding vector generated by the example embedding generator circuitry 116 can be used for applications other than voice calls. In some examples, one or more of the components of the communication device 112 and the communication device 206 are combined within a device, enabling the device to support multiple use cases of the user embedding vector. Advantageously, the example embedding generator circuitry 116 does not require a separate enrollment for any use case. As a result, the example embedding generator circuitry 116 reduces the amount of required computational resources and increases the quality of the user experience.

In some examples, the communication device 206 includes means for identifying a speaker. For example, the means for identifying may be implemented by identifier circuitry 208. In some examples, the identifier circuitry 208 may be instantiated by processor circuitry such as the example programmable circuitry 412 of FIG. 4. For instance, the identifier circuitry 208 may be instantiated by the example microprocessor 500 of FIG. 5 executing machine executable instructions. In some examples, the identifier circuitry 208 may be instantiated by hardware logic circuitry, which may be implemented by an ASIC, XPU, or the FPGA circuitry 600 of FIG. 6 structured to perform operations corresponding to the machine readable instructions. Additionally or alternatively, the identifier circuitry 208 may be instantiated by any other combination of hardware, software, and/or firmware. For example, the identifier circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the communication devices 112, 206 are illustrated in FIGS. 1 and 2, one or more of the elements, processes, and/or devices illustrated in FIGS. 1 and 2 may be combined, divided, re-arranged, omitted, eliminated, and/or implemented in any other way. Further, the example interface circuitry 114, the example embedding generator circuitry 116, example DNS circuitry 118, example transceiver circuitry 120, example identifier circuitry 208 and/or, more generally, the example communication devices 112, 206 of FIGS. 1 and 2, may be implemented by hardware alone or by hardware in combination with software and/or firmware. Thus, for example, any of the example interface circuitry 114, the example embedding generator circuitry 116, example DNS circuitry 118, example transceiver circuitry 120, example identifier circuitry 208 and/or, more generally, the example communication devices 112, 206, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example communication devices 112, 206 may include one or more elements, processes, and/or devices in addition to, or instead of, those illustrated in FIGS. 1 and 2, and/or may include more than one of any or all of the illustrated elements, processes and devices.

A flowchart representative of example machine readable instructions, which may be executed to configure processor circuitry to implement the example embedding generator circuitry 116 of FIGS. 1 and 2, is shown in FIG. 3. The machine readable instructions may be one or more executable programs or portion(s) of an executable program for execution by processor circuitry, such as the programmable circuitry 412 shown in the example programmable circuitry platform 400 discussed below in connection with FIG. 4 and/or the example processor circuitry discussed below in connection with FIGS. 5 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example embedding generator circuitry 116 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to generate a user embedding vector that is not obtained as part of an enrollment process. The machine readable instructions and/or the operations 300 of FIG. 3 begin when the example embedding generator circuitry 116 receives an input audio signal and applies a voice activity detector (VAD) or Wake on Voice (WoV) algorithm to the signal. (Block 302). As used above and herein, the input audio signal of block 302 refers to a finite amount of data corresponding to a particular period of audio activity. The example interface circuitry 114 generates the input audio signal based on a connection to a microphone that recorded the period of audio activity. The embedding generator circuitry 116 applies the VAD or WOV algorithm to identify human voices in the audio signal. In some examples, the embedding generator circuitry 116 uses a different algorithm to isolate human voices from the input audio signal at block 302.

The example embedding generator circuitry 116 uses the human voice only audio signal to calculate a sample embedding vector. (Block 304). As used above and herein, the embedding vector calculated in block 304 may be referred to as Eₛ. The example embedding generator circuitry 116 may form Eₛ using any network or digital signal processing (DSP) algorithm designed for speaker identification. Example techniques to calculate Et include, but are not limited to, Bi-Directional Long Short Term Memory (BiLS™) neural networks, Emphasized Channel Attention, Propagation and Aggregation Time Delay Neural Network (ECAPA-TDNN), etc. In some examples, the machine readable instructions and/or the operations 300 end at block 304 because the input audio signal is not long enough to support the calculation of Eₛ with a given network or DSP algorithm. In some examples, the formation of an embedding vector is referred to as encoding.

The example embedding generator circuitry 116 determines whether a personal embedding vector is empty. (Block 306). As used above and herein, the personal embedding vector may be referred to as Eₚ. Eₚ is an embedding vector that characterizes the voice of a particular individual (e.g., the main speaker 104). In contrast, Eₛ characterizes any voice present in the audio signal output of block 302, regardless of identity. Accordingly, when the example embedding generator circuitry 116 generates Eₛ at block 304, the voice is not yet identified and may be referred to as an unknown speaker.

In the first iteration of the machine readable instructions and/or operations 300, Eₚ is empty (Block 306: Yes). In such examples, control proceeds to block 312. In subsequent iterations, Eₚ contains data (Block 306: No) and control proceeds to block 308.

The example embedding generator circuitry 116 performs a distance calculation between Eₛ and Eₚ. To perform the distance calculation, the example embedding generator circuitry 116 may use any technique that quantifies the similarity between two sets of data. Example types of distances measured at block 308 include but are not limited to Euclidean Distance, Manhattan Distance, Minkowski Distance, Hamming Distance, etc.

The example embedding generator circuitry 116 determines whether to update Eₚ. (Block 310). To determine whether to update Eₚ, the embedding generator circuitry 116 determines whether the output of the distance calculation satisfies a threshold. For example, if the output of the distance calculation at block 308 is greater than a pre-determined distance value, Eₛ is sufficiently similar to Eₚ and the threshold is satisfied (Block 310: Yes). In such an example, if the output of the distance calculation at block 308 is less than or equal to than the pre-determined distance value, Eₛ is not sufficiently similar to Eₚ and the distance calculation does not satisfy the threshold (Block 310: No).

If the distance calculation does not satisfy the threshold (Block 310: No), Eₚ is not updated and control proceeds to block 316. Alternatively, if the distance calculation does satisfy the threshold (Block 310: Yes), the example embedding generator circuitry 116 performs a first update of Eₚ using Eₛ. (Block 312). The update of block 312 is given by equation (1):

$${E}_{p} = α \cdot {E}_{p} + ( 1 - α ) \cdot {E}_{s} \qquad ( 1 )$$

In equation (1), Eₚ is the personal embedding vector as described above and Eₛ is the sample embedding vector as described above. Equation (1) also introduces α, a value between [0, 1]. In some examples, a is referred to as a ratio because the value describes how a particular update of Eₚ is based on the previous version of Eₚ. α additionally describes how much the particular update is based on Eₛ.

The example embedding generator circuitry 116 performs a second update of Eₚ with a universal embedding vector. (Block 314). As used above and herein, the universal embedding vector may be referred to as Eᵤ. E_{U} is generated using audio from a large set of individuals who have varying demographics but speak the same language. Accordingly, E_{U} is an embedding that accurately characterizes a generic human voice in a particular language. In some examples, E_{U} is a pre-determined value stored in a memory accessible to the example embedding generator circuitry 116. The example embedding generator circuitry 116 performs the update of block 312 using equation (2):

$${E}_{p} = β \cdot {E}_{U} + ( 1 - β ) \cdot {E}_{P} \qquad ( 2 )$$

In equation (2), β refers to a value between [0, 1]. In some examples, B is referred to as a ratio because the value describes how a particular update of Eₚ is based on E_{U}. β additionally describes how much the particular update is based on the previous version of Eₚ (i.e., the output of block 312). The example embedding generator circuitry 116 also provides Eₚ to the DNS circuitry 118 or identifier circuitry 208 at block 314.

The example embedding generator circuitry 116 determines whether the example interface circuitry 104 has generated another input audio signal. (Block 316). If the example interface circuitry 104 has generated another input audio signal (Block 316: Yes), control returns to block 302 where the example embedding generator circuitry 116 isolates human voice in the new input audio signal. If the example interface circuitry 104 has not generated another input audio signal (Block 316: No), the machine readable instructions and/or operations 300 end.

The example embedding generator circuitry 116 may make the determination of block 316 any amount of time after block 314. In some examples, the example embedding generator circuitry 116 implements block 318 iteratively and performs multiple checks for another input audio signal.

FIG. 3 is an example flowchart that may be used to implement the example embedding generator circuitry 116. Advantageously, the flowchart shows that the personal embedding vector Eₚ can be updated any number of times. As a result, Eₚ can adapt to changes in the voice of the speaker due to aging, illness, etc. The continuous updates also enable Eₚ to adapt to changes in device location, which can lead to different parasitic noise audio profiles and/or different parasitic speaker audio profiles.

Additionally, the example embedding generator circuitry 116 can adjust the values of a and/or β between updates so that Eₚ can remain both personalized and accurate. For example, in early iterations of the loop formed by blocks 302-316, Eₚ is based on a relatively small number of input audio signals. In such early iterations, the example embedding generator circuitry 116 may use values near 0 for a and values near 1 for β so that Eₚ is predominantly based on the large sample set used to form E_{U}, and so that any inaccuracies caused by variances in the relatively small number of input audio signals are mitigated.

As the number of iterations of the loop formed by blocks 302-316 increases, the number of input audio signals increases and there is less variance within the expanded data set. Accordingly, as the number of iterations of the loop formed by blocks 302-316 increases, the example embedding generator circuitry 116 may gradually increase the value of a to increase the magnitude of the vector α· Eₚ in equation (1). Similarly, as the number of iterations of the loop formed by blocks 302-316 increases, the example embedding generator circuitry 116 may gradually decrease the value of β to decrease the magnitude of the vector β·E_{U} in equation (2). As a result, the example embedding generator circuitry 116 generates an embedding vector based on a speaker that: 1) does not require a separate enrollment process, 2) is accurate at all times, and 3) becomes increasingly personalized over subsequent usage.

FIG. 4 is a block diagram of an example programmable circuitry platform 400 structured to execute and/or instantiate the machine readable instructions and/or the operations of FIG. 3 to implement the communication devices 112, 206 of FIGS. 1 and 2. The programmable circuitry platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the example embedding generator circuitry 116, example DNS circuitry 118, and example identifier circuitry 208.

The programmable circuitry 412 of the illustrated example includes a local memory 413 (e.g., a cache, registers, etc.). The programmable circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 420 implements the example interface circuitry 114 and the example transceiver circuitry 120.

In the illustrated example, one or more input devices 422 are connected to the interface circuitry 420. The input device(s) 422 permit(s) a user to enter data and/or commands into the programmable circuitry 412. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 432, which may be implemented by the machine readable instructions of FIG. 3, may be stored in the mass storage device 428, in the volatile memory 414, in the non-volatile memory 416, and/or on a removable non-transitory computer readable storage medium such as a CD or DVD.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowchart of FIG. 3 to effectively instantiate the circuitry of FIGS. 1 and 2 as logic circuits to perform operations corresponding to those machine readable instructions. In some such examples, the circuitry of FIGS. 1 and 2 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart(s) of FIG. 3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 600 may be configured and/or structured to effectively instantiate some or all of the operations/functions corresponding to the machine readable instructions of the flowchart(s) of FIG. 3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIG. 3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIG. 3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart(s) of FIG. 3 to perform first operation(s)/function(s), the FPGA circuitry 600 of FIG. 6 may be configured and/or structured to perform second operation(s)/function(s) corresponding to a second portion of the machine readable instructions represented by the flowcharts of FIG. 3, and/or an ASIC may be configured and/or structured to perform third operation(s)/function(s) corresponding to a third portion of the machine readable instructions represented by the flowchart of FIG. 3.

It should be understood that some or all of the circuitry of FIGS. 1 and 2 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIGS. 1 and 2 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIGS. 1 and 2 may be implemented within one or more virtual machines and/or containers executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIG. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

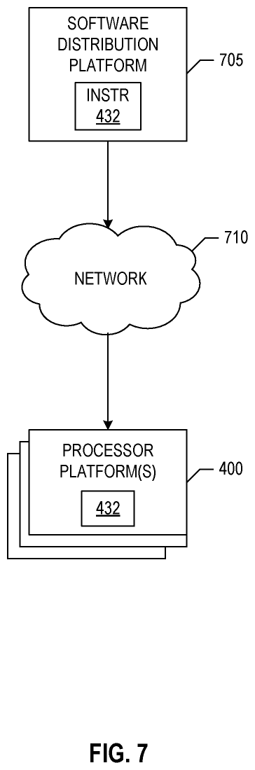

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIG. 3, as described above. The one or more servers of the example software distribution platform 705 are in communication with an example network 710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIG. 3, may be downloaded to the example programmable circuitry platform 400, which is to execute the machine readable instructions 432 to implement the communication devices 112, 206. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that improve user experience by generating a personalized embedding vector of a speaker's voice without an enrollment process. Disclosed systems, methods, apparatus, and articles of manufacture improve the efficiency of using a computing device by reducing the computational resource requirements needed to generate a personalized embedding vector by eliminating the enrollment process, and by increasing the accuracy of the personalized embedding vector through iterative updates with variable emphasis on Eₛ, Eₚ, and E_{U}. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to model speaker audio are disclosed herein. Further examples and combinations thereof include the following.

Example 1 includes an apparatus to model speaker audio comprising interface circuitry to obtain a first audio signal, and computer readable instructions, and programmable circuitry to instantiate embedding generator circuitry to identify a speaker in the first audio signal, calculate a sample embedding vector that characterizes the speaker based on the first audio signal, perform a first update of a personal embedding vector based on the sample embedding vector, the updated personal embedding vector to characterize the speaker based on a second audio signal and the first audio signal, the second audio signal obtained before the first audio signal, and perform a second update of the personal embedding vector based on the first update and a universal embedding vector that characterizes human voice.

Example 2 includes the apparatus of example 1, wherein the first audio signal includes the speaker and parasitic noise, the apparatus further includes dynamic noise suppression circuitry to output, based on the personal embedding vector after the second update and the first audio signal, main speaker audio that includes the speaker but not the parasitic noise, and transceiver circuitry to transmit the main speaker audio over a network.

Example 3 includes the apparatus of example 1, wherein the apparatus corresponds to a first user and a second user, and the apparatus further includes identifier circuitry to identify, based on the personal embedding vector after the second update, the speaker as one of the first user or the second user.

Example 4 includes the apparatus of example 1, wherein the first audio signal is not part of an enrollment process.

Example 5 includes the apparatus of example 1, wherein to perform the first update of the personal embedding vector, the embedding generator circuitry is to obtain a previous version of the personal embedding vector, determine a ratio, and combine a first vector and a second vector, the first vector based on the previous version of the personal embedding vector and the ratio, the second vector based on the sample embedding vector and the ratio.

Example 6 includes the apparatus of example 1, wherein the speaker is a first speaker, the sample embedding vector is a second sample embedding vector corresponding to the first audio signal, the interface circuitry is to obtain a third audio signal after the first audio signal, and the embedding generator circuitry is to identify an unknown speaker in the third audio signal, calculate a third sample embedding vector that characterizes the unknown speaker based on the third audio signal, and determine whether to perform an additional update of the personal embedding vector with the third sample embedding vector, the determination based on a distance calculation between the personal embedding vector and the third sample embedding vector.

Example 7 includes the apparatus of example 1, wherein to perform the second update of the personal embedding vector, the embedding generator circuitry is to determine a ratio, and combine a first vector and a second vector, the first vector based on the personal embedding vector after the first update and the ratio, the second vector based on the universal embedding vector and the ratio.

Example 8 includes the apparatus of example 7, wherein the embedding generator circuitry is to change the ratio over subsequent iterations so that a magnitude of the first vector increases and a magnitude of the second vector decreases.

Example 9 includes the apparatus of example 1, wherein the programmable circuitry includes one or more of at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations.

Example 10 includes a non-transitory machine readable storage medium comprising instructions to cause programmable circuitry to at least identify a speaker in a first audio signal, calculate a sample embedding vector that characterizes the speaker based on the first audio signal, perform a first update of a personal embedding vector based on the sample embedding vector, the updated personal embedding vector to characterize the speaker based on a second audio signal and the first audio signal, the second audio signal obtained before the first audio signal, and perform a second update of the personal embedding vector based on the first update and a universal embedding vector that characterizes human voice.

Example 11 includes the non-transitory machine readable storage medium of example 10, wherein the first audio signal includes the speaker and parasitic noise, and the instructions cause the programmable circuitry to output, based on the personal embedding vector after the second update and the first audio signal, main speaker audio that includes the speaker but not the parasitic noise, and transmit the main speaker audio over a network.

Example 12 includes the non-transitory machine readable storage medium of example 10, wherein the programmable circuitry corresponds to a first user and a second user, and the instructions cause the programmable circuitry to identify, based on the personal embedding vector after the second update, the speaker as one of the first user or the second user.

Example 13 includes the non-transitory machine readable storage medium of example 10, wherein the first audio signal is not part of an enrollment process.

Example 14 includes the non-transitory machine readable storage medium of example 10, wherein to perform the first update of the personal embedding vector, the instructions cause the programmable circuitry to obtain a previous version of the personal embedding vector, determine a ratio, and combine a first vector and a second vector, the first vector based on the previous version of the personal embedding vector and the ratio, the second vector based on the sample embedding vector and the ratio.

Example 15 includes the non-transitory machine readable storage medium of example 10, wherein the speaker is a first speaker, the sample embedding vector is a second sample embedding vector corresponding to the first audio signal, and the instructions cause the programmable circuitry to obtain a third audio signal after the first audio signal, identify an unknown speaker in the third audio signal, calculate a third sample embedding vector that characterizes the unknown speaker based on the third audio signal, and determine whether to perform an additional update of the personal embedding vector with the third sample embedding vector, the determination based on a distance calculation between the personal embedding vector and the third sample embedding vector.

Example 16 includes the non-transitory machine readable storage medium of example 10, wherein to perform the second update of the personal embedding vector, the instructions cause the programmable circuitry to determine a ratio, and combine a first vector and a second vector, the first vector based on the personal embedding vector after the first update and the ratio, the second vector based on the universal embedding vector and the ratio.

Example 17 includes the non-transitory machine readable storage medium of example 16, wherein the instructions cause the programmable circuitry to change the ratio over subsequent iterations so that a magnitude of the first vector increases and a magnitude of the second vector decreases.

Example 18 includes a method to model speaker audio, the model comprising identifying a speaker in a first audio signal, calculating a sample embedding vector that characterizes the speaker based on the first audio signal, performing a first update of a personal embedding vector based on the sample embedding vector, the updated personal embedding vector to characterize the speaker based on a second audio signal and the first audio signal, the second audio signal obtained before the first audio signal, and performing a second update of the personal embedding vector based on the first update and a universal embedding vector that characterizes human voice.

Example 19 includes the method of example 18, wherein the first audio signal includes the speaker and parasitic noise, and the method further includes outputting, based on the personal embedding vector after the second update and the first audio signal, main speaker audio that includes the speaker but not the parasitic noise, and transmitting the main speaker audio over a network.

Example 20 includes the method of example 18, wherein further including identifying, based on the personal embedding vector after the second update, the speaker as one of a first user or a second user.

Example 21 includes the method of example 18, wherein the first audio signal is not part of an enrollment process.

Example 22 includes the method of example 18, wherein performing the first update of the personal embedding vector further includes obtaining a previous version of the personal embedding vector, determining a ratio, and combining a first vector and a second vector, the first vector based on the previous version of the personal embedding and the ratio, the second vector based on the sample embedding vector and the ratio.

Example 23 includes the method of example 18, wherein the speaker is a first speaker, the sample embedding vector is a second sample embedding vector corresponding to the first audio signal, and the method further includes obtaining a third audio signal after the first audio signal, identifying an unknown speaker in the third audio signal, calculating a third sample embedding vector that characterizes the unknown speaker based on the third audio signal, and determining whether to perform an additional update of the personal embedding vector with the third sample embedding vector, the determining based on a distance calculation between the personal embedding vector and the third sample embedding vector.

Example 24 includes the method of example 18, wherein performing the second update of the personal embedding vector further includes determining a ratio, and combining a first vector and a second vector, the first vector based on the personal embedding vector after the first update and the ratio, the second vector based on the universal embedding vector and the ratio.

Example 25 includes the method of example 24, further including changing the ratio over subsequent iterations so that a magnitude of the first vector increases and a magnitude of the second vector decreases.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
interface circuitry;
instructions; and
programmable circuitry to at least one of execute or instantiate the instructions to:
calculate a sample embedding vector that characterizes a speaker based on a first audio signal;
perform a first update of a personal embedding vector based on the sample embedding vector, the updated personal embedding vector to characterize the speaker based on a second audio signal and the first audio signal; and
perform a second update of the personal embedding vector based on the first update and a universal embedding vector.

2. The apparatus of claim 1, wherein the first audio signal includes audio from the speaker and parasitic noise, and the apparatus further includes:
dynamic noise suppression circuitry to output, based on the personal embedding vector after the second update, main speaker audio that includes the speaker but not the parasitic noise; and
transceiver circuitry to transmit the main speaker audio.

3. The apparatus of claim 1, wherein the apparatus corresponds to a first user and a second user, and the apparatus further includes:
identifier circuitry to identify, based on the personal embedding vector after the second update, the speaker as the first user or the second user.

4. The apparatus of claim 1, wherein the first audio signal is not obtained as part of an enrollment process.

5. The apparatus of claim 1, wherein to perform the first update of the personal embedding vector, the programmable circuitry is to:
determine a ratio; and
combine a first vector and a second vector,
the first vector based on a previous version of the personal embedding vector and the ratio,
the second vector based on the sample embedding vector and the ratio.

6. The apparatus of claim 1, wherein:
the speaker is a first speaker; the sample embedding vector is a second sample embedding vector corresponding to the first audio signal; and the programmable circuitry is to:
identify an unknown speaker in a third audio signal;
calculate a third sample embedding vector based on the third audio signal; and
determine whether to perform an additional update of the personal embedding vector with the third sample embedding vector, the determination based on a distance calculation between the personal embedding vector and the third sample embedding vector.

7. The apparatus of claim 1, wherein to perform the second update of the personal embedding vector, the programmable circuitry is to:
determine a ratio; and
combine a first vector and a second vector, the first vector based on the personal embedding vector after the first update and the ratio, the second vector based on the universal embedding vector and the ratio.

8. The apparatus of claim 7, wherein the programmable circuitry is to change the ratio over subsequent iterations so that a magnitude of the first vector increases and a magnitude of the second vector decreases.

9. The apparatus of claim 1, wherein the second audio signal is obtained before the first audio signal.

10. The apparatus of claim 1, wherein the universal embedding vector characterizes human voice.

11. The apparatus of claim 1, wherein the programmable circuitry includes one or more of:
at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.

12. A non-transitory machine readable storage medium comprising instructions to cause programmable circuitry to at least:
calculate a sample embedding vector that characterizes a speaker based on a first audio signal;
update a personal embedding vector to an updated personal embedding vector based on the sample embedding vector, the updated personal embedding vector to characterize the speaker based on a second audio signal and the first audio signal; and
update the updated personal embedding vector to a second updated personal embedding vector based on a universal embedding vector.

13. The non-transitory machine readable storage medium of claim 12, wherein:
the first audio signal includes audio from the speaker and parasitic noise; and
the instructions cause the programmable circuitry to:
generate main speaker audio based on the second updated personal embedding vector and the first audio signal, the main speaker audio includes the audio from the speaker but not the parasitic noise; and
cause transmission of the main speaker audio.

14. The non-transitory machine readable storage medium of claim 12, wherein the instructions cause the programmable circuitry to identify the speaker as one of a first user or a second user based on the second updated personal embedding vector.

15. The non-transitory machine readable storage medium of claim 12, wherein the first audio signal is not obtained as part of an enrollment process.

16. The non-transitory machine readable storage medium of claim 12, wherein to update the personal embedding vector to the updated personal embedding vector, the instructions cause the programmable circuitry to:
determine a ratio; and
combine a first vector and a second vector,
the first vector based on a previous version of the personal embedding vector and the ratio,
the second vector based on the sample embedding vector and the ratio.

17. The non-transitory machine readable storage medium of claim 12, wherein the instructions cause the programmable circuitry to:
calculate a third sample embedding vector that characterizes an unknown speaker based on a third audio signal; and
determine whether to perform an additional update of the personal embedding vector with the third sample embedding vector, the determination based on a distance calculation between the personal embedding vector and the third sample embedding vector.

18. The non-transitory machine readable storage medium of claim 12, wherein to update the updated personal embedding vector to a second updated personal embedding vector, the instructions cause the programmable circuitry to:
determine a ratio; and
combine a first vector and a second vector, the first vector based on the updated personal embedding vector and the ratio, the second vector based on the universal embedding vector and the ratio.

19-21. (canceled)

22. A method to model speaker audio, the method comprising:
calculating a sample embedding vector α based on a first audio signal;
performing, by executing an instruction with at least one processor, a first update of a personal embedding vector based on the sample embedding vector, the updated personal embedding vector to characterize a speaker based on a second audio signal and the first audio signal; and
performing a second update of the personal embedding vector based on the first update and a universal embedding vector.

23-24. (canceled)

25. The method of claim 22, wherein the first audio signal is not obtained part of an enrollment process.

26-31. (canceled)
